(19) United States
(12) Patent Application Publication
(10) Pub. No.: US 2017/0073788 A1
(43) Pub. Date: Mar. 16, 2017

(54) METHOD OF MANUFACTURING BUMPER BACK BEAM FOR VEHICLES

(71) Applicants: Hyundai Motor Company, Seoul (KR); Kia Motors Corporation, Seoul (KR); Sung Woo Hitech Co., Ltd., Busan (KR)

(72) Inventors: Hyun Gyung Kim, Hwaseong (KR); Jin Young Yoon, Gimpo (KR); Si Young Park, Jangseong (KR); Dong Eun Cha, Suwon (KR); Mun Yong Lee, Busan (KR); Dae Jung Kim, Suwon (KR)

(21) Appl. No.: 14/942,215

(22) Filed: Nov. 16, 2015

(30) Foreign Application Priority Data
Sep. 11, 2015 (KR) 10-2015-0129040

(51) Int. Cl. C21D 9/00; B23K 9/007; B21D 47/01; C21D 7/06; C21D 1/18; B60R 19/18; B23K 26/22; B23K 11/11

(52) U.S. Cl. CPC C21D 9/0068; B23K 26/22; B23K 9/007; B23K 11/11; C21D 7/06; C21D 1/18; B60R 19/18; B21D 47/01; B23K 2201/006

(57) ABSTRACT

A method of manufacturing a bumper back beam for vehicles is provided. The method includes shaping a planar strip using a pressing process and a planar surface component are formed within a central portion of the strip in a longitudinal direction thereof, and recessed components are formed on opposite sides of the planar surface part, and a first flange is formed on an exterior edge of each recessed component. Further, each of the recessed components are bent vertically around a bending boundary line formed between the planar surface component and the corresponding recessed component and the opposite first flanges contact the planar surface component. Additionally, the edges of the opposite first flanges are welded to the planar surface component and the back beam has a pair of closed section components defined by the planar surface component and the recessed components.

### CROSS REFERENCE TO RELATED APPLICATION

The present application claims priority to Korean Patent Application No. 10-2015-0129040, filed Sep. 11, 2015, the entire contents of which is incorporated herein for all purposes by this reference.

### BACKGROUND

1. Field of the Invention

The present invention relates to a method of manufacturing a back beam of a bumper, which absorbs impact force applied when a vehicle collision occurs.

2. Description of the Related Art

Vehicles include various types of safety devices for protecting passengers from transmission of impact force generated when a vehicle collision occurs. For example, a bumper absorbs impact energy generated when a collision occurs, through variation in structure or material. Generally, bumpers are installed on the front and rear of a vehicle. Typically, the bumpers are mounted to a basic frame of the vehicle. For example, bumpers are components which receive the initial impact when a vehicle collision occurs. During the collision, the bumper must be capable of deforming to absorb a sufficient amount of impact energy, thus reducing impact force received by the passengers. However, conventional techniques for manufacturing bumpers have a closed section, for example, a plurality of separate components are connected to each other to form the bumper. Therefore, stress is concentrated on the junction between the components. In particular, the junction of the bumper may be easily deformed or ruptured. In other words, the bumper may not be able to sufficiently absorb the intended energy upon impact.

The foregoing is intended merely to aid in the understanding of the background of the present invention, and is not intended to mean that the present invention falls within the purview of the related art that is already known to those skilled in the art.

### SUMMARY

The present invention provides method of manufacturing a bumper back beam having a closed section. The method may reduce the number of components of the back beam, and may increase the strength of a welded portion of the back beam by using a hot forming process.

According to one aspect of an exemplary embodiment, a method of manufacturing a bumper back beam for vehicles may include shaping a planar strip using a pressing process to form a planar surface component within a central portion of the strip in a longitudinal direction thereof, recessed components that extend in the longitudinal direction and protrude downward may be formed on respective opposite sides of the planar surface part. A first flange may include a planar shape formed on an exterior edge of each of the recessed components. The method may further include each of the opposite recessed components may bend vertically around a bending boundary line formed between the planar surface component and the recessed component that corresponds to the opposite first flanges and contacts an upper surface of the planar surface component. The planar surface component may include welded edges of the opposite first flanges that contact the upper surface of the planar surface component so that the bumper back beam includes a pair of closed section components defined by the planar surface component and the opposite recessed components.

The first flanges may be disposed within central portion of the bumper back beam, and second flanges may extend in a vertical direction and may be formed on center-side edges of the respective first flanges. During the bending process, the opposite recessed components may be bent in a vertical direction, based on respective longitudinal bending lines disposed within the bottom surfaces of the respective recessed components. The opposite second flanges may contact the upper surface of the planar surface component. The welding process may include, welding edges of the opposite second flanges that contact the upper surface of the planar surface component to the planar surface component. The bumper back beam may include a pair of closed section components defined by the recessed components.

During the shaping process, the first flanges may be formed to be level with the planar surface part. The welding process may include welding the edges of the first flanges to the planar surface component by spot welding, arc welding or laser welding. The method may further include, heating the back beam, forming the heated back beam in an arched shape with respect to the longitudinal direction, and quenching the formed back beam and, processing a surface of the bumper back beam. The forming the bumper back beam may include varying a curvature from a medial portion thereof to opposite ends, wherein the bumper back beam may have a symmetrical structure based on the medial portion thereof. The processing may include exposing the surface of the bumper back beam using a shot blasting process.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is an exemplary sectional view of a bumper back beam for vehicles that is formed using a shaping process according to an exemplary embodiment of the present invention;

FIG. 2 is an exemplary sectional view of the bumper back beam according to the exemplary embodiment of FIG. 1;

FIG. 3 is an exemplary sectional view of a bumper back beam for vehicles that is formed using a shaping process according to another exemplary embodiment of the present invention;

FIG. 4 is an exemplary sectional view of the bumper back beam according to the exemplary embodiment of FIG. 3;

FIG. 5 is an exemplary perspective view of the bumper back beam after a welding process according to an exemplary embodiment of the present invention;

FIG. 6 is an exemplary perspective view of the bumper back beam according to the exemplary embodiment of the present invention;

FIG. 7 is an exemplary plan view of the bumper back beam according to the exemplary embodiment of the present invention; and

FIG. 8 is an exemplary flowchart showing a method of manufacturing a bumper back beam for vehicles according to an exemplary embodiment of the present invention.

### DETAILED DESCRIPTION

Hereinafter reference will now be made in detail to various exemplary embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicle in general such as passenger automobiles including sports utility vehicles (SUV), buses, trucks, various commercial vehicles, watercraft including a variety of boats, ships, aircraft, and the like and includes hybrid vehicles, electric vehicles, combustion, plug-in hybrid electric vehicles, hydrogen-powered vehicles and other alternative fuel vehicles (e.g. fuels derived from resources other than petroleum).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, in order to make the description of the present invention clear, unrelated parts are not shown and, the thicknesses of layers and regions are exaggerated for clarity. Further, when it is stated that a layer is “on” another layer or substrate, the layer may be directly on another layer or substrate or a third layer may be disposed therebetween.

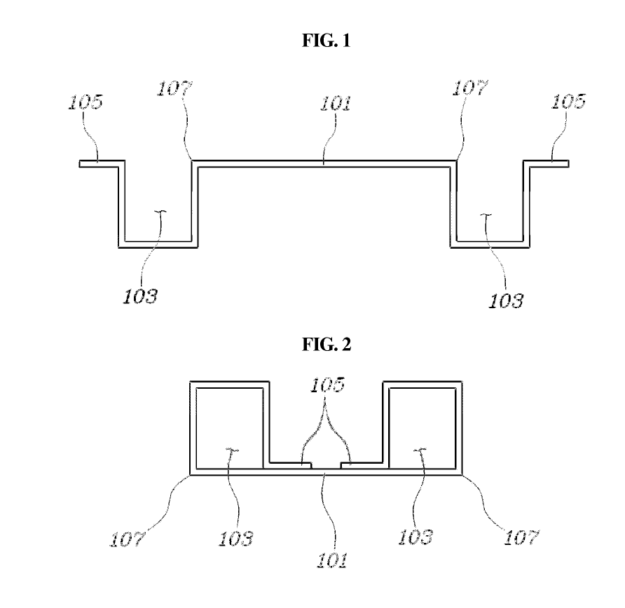

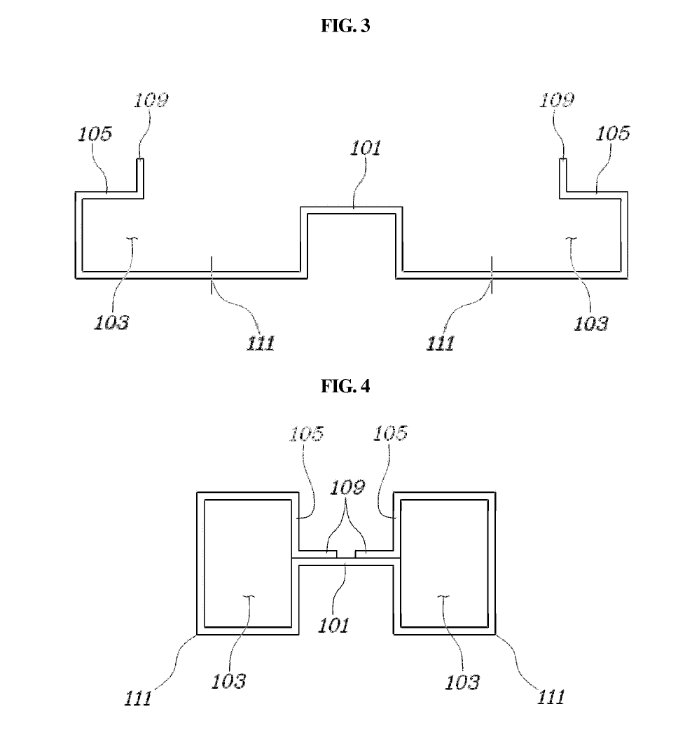

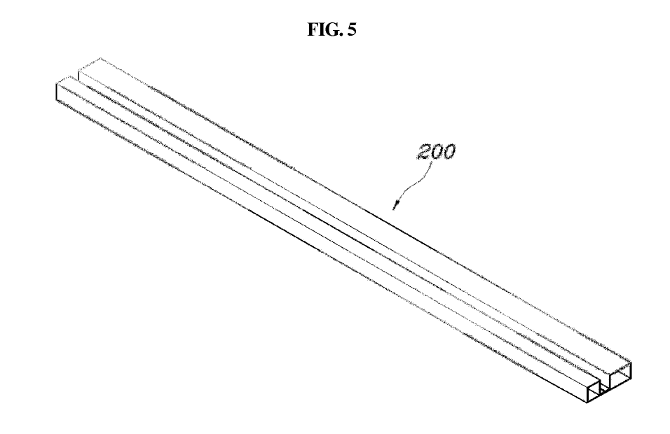

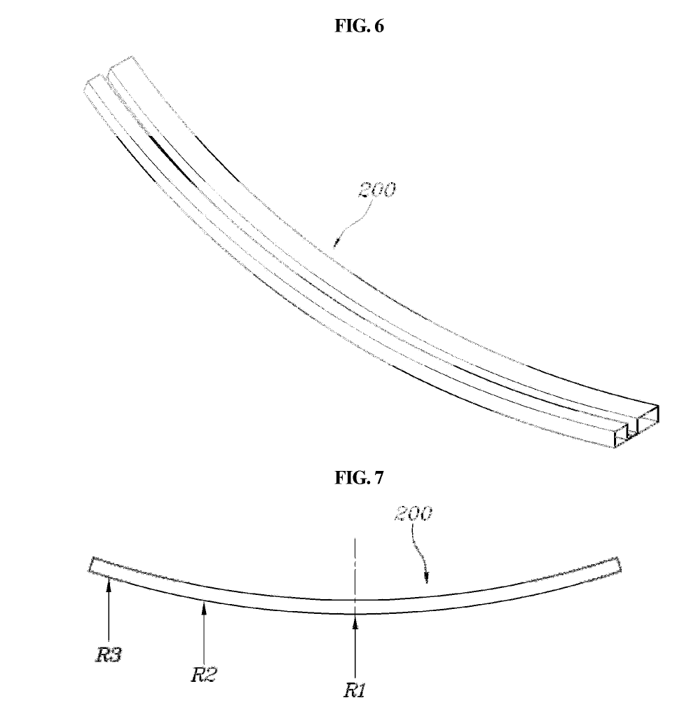

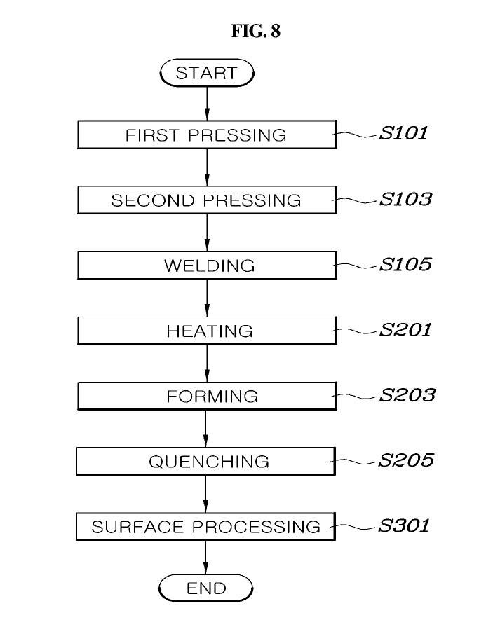

FIG. 1 is an exemplary sectional view of a bumper back beam for vehicles that may be formed using a shaping process S101 according to an exemplary embodiment of the present invention. FIG. 2 is an exemplary sectional view of the bumper back beam according to the exemplary embodiment of FIG. 1. FIG. 3 is an exemplary sectional view of a bumper back beam for vehicles that may be formed using a shaping process S101 according to another exemplary embodiment of the present invention. FIG. 4 is an exemplary sectional view of the bumper back beam according to the exemplary embodiment of FIG. 3. FIG. 5 is an exemplary perspective view of the bumper back beam after welding process S105 according to an exemplary embodiment of the present invention. FIG. 6 is an exemplary perspective view of the bumper back beam according to the exemplary embodiment of the present invention. FIG. 7 is an exemplary plan view of the bumper back beam according to the exemplary embodiment of the present invention. FIG. 8 is an exemplary flowchart showing a method of manufacturing a bumper back beam for vehicles according to an exemplary embodiment of the present invention.

The method of manufacturing the bumper back beam for vehicles according to the exemplary embodiment of the present invention may include a planar strip using a pressing process S101 to form a planar surface component 101 within a central portion of the strip in a longitudinal direction thereof. Recessed components 103 each of which extends in the longitudinal direction and protrude downward may be formed on opposite sides of the planar surface component 101, respectively. A first planar flange 105 may be formed on an exterior edge of each of the recessed components 103 and each of the opposite recessed components 103 may be bent S103 vertically around a bending boundary line 107 formed between the planar surface component 101 and the corresponding recessed component 103. For example, the opposite flanges 105 may contact an upper surface of the planar surface component 101 the planar surface component 101, may be welded S105 to the edges of the flanges 105 that contact the upper surface of the planar surface component 101. Additionally, the bumper back beam may include a pair of closed section components defined by the planar surface component 101 and the opposite recessed components 103.

In particular, during the shaping process S101, the flanges may be formed to be level with the planar surface component 101. Additionally, during the welding process S105, the edges of the flanges may be welded to the planar surface component 101 by spot welding, arc welding or laser welding. When two planar strips are used to form a structure having closed section components, a junction on which the two planar strips are connected to each other by welding, force fitting, etc.. For example, the portions of the planar strips that form the junction may be deformed during the welding process. Alternately, the properties thereof may differ from the other portions due to a structural coupling rather than a material coupling. In particular, when an external impact is applied to the bumper back beam, impact force may be focused on the junction between the two planar strips. Accordingly, the junction may be undesirably bent or broken. Therefore, the forming process of the bumper back beam reduces the number of junctions and reduces the number of times of welding.

According to an exemplary embodiment of the bumper back beam manufacturing method, a bumper back beam may include a plurality of closed section components manufactured by shaping a single planar strip, whereby the number of portions to be welded may be reduced to one. The process of manufacturing the bumper back beam will be described in detail with reference to FIGS. 1 and 2.

The planar strip may shaped to include the planar surface component 101 may be formed within the central portion of the planar strip in the longitudinal direction thereof S101. The recessed components 103 that extend in the longitudinal direction and protrude downward may be formed on the opposite exterior sides of the planar surface component 101. The first planar flanges 105 may extend outward from the exterior edges of the recessed components 103. The opposite recessed components 103 may be bent vertically S103 around the corresponding bending boundary lines 107 formed between the planar surface component 101 and the recessed components 103 and the flanges 105 contact the upper surface of the planar surface component 101. In particular, the edges of the flanges 105 may contact each other or be spaced apart from each other. The edges of the flanges 105 that contact the upper surface of the planar surface component 101 may be welded S105 to the planar surface component 101. Additionally, the bumper back beam may have a pair of closed section components defined by the planar surface component 101 and the recessed components 103.

In another exemplary embodiment, a method of manufacturing a bumper back beam having a figure-eight shaped cross-section with a planar surface component 101 formed in a center thereof will be described. During the shaping process S101, a planar strip may be shaped to include first flanges 105 are formed to be oriented toward the central portion of the bumper back beam and second flanges 109 that extend vertically and formed on center-side edges of the respective first flanges 105. During the bending process S103, opposite recessed components 103 may be bent vertically, based on respective longitudinal bending lines 111 disposed within the bottom surfaces of the respective recessed components 103. Accordingly, the opposite second flanges 109 contact the upper surface of the planar surface component 101. Further, during the welding process S105, edges of the opposite second flanges 109 that contact the upper surface of the planar surface component 101 may be welded to the planar surface component 101 and the bumper back beam may have a pair of closed section components defined by the recessed components 103.

In other words, retelling to FIGS. 3 and 4, shaping the planar strip S101 may include forming the first flanges 105 oriented toward the center of the bumper back beam and the second flanges 109 that extend vertically on the center-side edges of the respective first flanges 105. Furthermore, the opposite recessed components 103 may be bent vertically S103, based on the respective longitudinal bending lines 111 disposed within the bottom surfaces of the respective recessed components 103. Accordingly, the opposite second flanges 109 contact the upper surface of the planar surface component 101. In particular, the edges of the first flanges 109 may contact each other or may be spaced apart (e.g., separated) from each other. Further, each bending line 111 may be disposed within the bottom surface that corresponds to the recessed component 103 at a position spaced apart from the exterior edge of the planar surface component 101 outward by a width of the closed section component. The edges of the opposite second flanges 109 may be welded S105 to the planar surface component 101.

After welding S105, the method may further include heating S201 the back beam 200; forming S203 the heated back beam 200 having an arched shape with respect to the longitudinal direction; and quenching S205 the formed back beam 200. For example, when the back beam 200 has been processed by welding is directly bent, the welded portion may be unable to withstand expansion and compression of the material attributable to the bending and may rupture.

Retelling to FIGS. 6 and 7, the method of the bumper back beam 200 according to an exemplary embodiment of the present invention, the back beam 200 may be processed to have an arched shape after heating the back beam 200 to be flexible. Thereby, the probability of the welded portion being ruptured during the forming process may be reduced. Furthermore, the welded portion as well as the other portions of the back beam 200 may be processed by quenching S205, whereby the strength of the welded portion may be enhanced. Consequently, the material strength of the welded portion may become similar to that of the other portions of the back beam 200.

For example, when a plate having a material strength ranging from about 50 kgf to 60 kgf is used to form the back beam, the strength of the welded portion may range from about 70 kgf to 100 kgf. However, after quenching S205, the strength of the material may be increased to a range between about 170 kgf to 200 kgf, and the strength of the welded portion may also be enhanced to about 170 kgf or greater. The back beam 200 may be formed S203 and the curvature thereof varies from the medial portion of the back beam 200 to the opposite ends thereof. Additionally, the back beam 200 may have a symmetrical structure based on the medial portion thereof.

Retelling to FIGS. 6 and 7, according to an exemplary embodiment, during forming S203, a process of curving the back beam 200 may be performed in the various curvatures R1, R2 and R3 may be applied to different portions of the back beam 200. The back beam 200 may be formed to have a bilateral symmetric arched shape with a protruding medial portion, rather than having a linear shape. Therefore, the back beam 200 may reduce aerodynamic resistance and effectively absorb and disperse impact energy during a head-on collision and an oblique collision. After completion of quenching S205, the method may further include a processing S301 the surface of the back beam.

Furthermore, during surface processing S301, a shot blasting method may be used to process the surface of the back beam 200. The shot blasting method may include a processing method that forcibly propels a stream of hard particles against a surface of a target using compressed air or the like to remove surface contaminants, corroded substances, etc., thus smoothing the surface. Additionally, the back beam has been processed through the quenching S205 the back beam has been treated by a surface processing method such as a shot blasting method. In other words, foreign substances may be removed, and the surface of the back beam may be processed to be smoother. Thereby, the completeness of a painting operation or the like to be performed for rust prevention may be improved.

As described above, in a method of manufacturing a bumper back beam for vehicles according to the present invention, the number of components of a bumper may be reduced. In particular, the number of welding joints may be reduced, and the strength of a welded portion may be enhanced to a degree similar to that of the other portions.

While this invention has been described in connection with what is presently considered to be exemplary embodiments on the contrary, it is intended to cover various modifications and equivalent arrangements without departing from the spirit and scope of the present invention as defined by the following claims. In addition, it is to be considered that all of these modifications and alterations fall within the scope of the present invention.

What is claimed is:

1. A method of manufacturing a bumper back beam for vehicles, comprising:
shaping a planar strip using a pressing process, a planar surface component is formed in a central portion of the strip in a longitudinal direction thereof, recessed components each of which extend in the longitudinal direction and protrudes downward are formed on opposite sides of the planar surface part, and a first flange having a planar shape is formed on an exterior edge of each of the recessed components;
bending each of the opposite recessed components vertically around a bending boundary line formed between the planar surface component and the corresponding recessed component and the opposite first contacts an upper surface of the planar surface part; and
welding, to the planar surface part, edges of the opposite first flanges that contact the upper surface of the planar surface component and the bumper back beam has a pair of closed section components defined by the planar surface component and the opposite recessed components.

2. The method according to claim 1, wherein:
the shaping includes forming, the first flanges to be disposed toward a central portion of the bumper back beam, and second flanges extending vertically are formed on center-side edges of the respective first flanges;
the bending further includes, vertically bending the opposite recessed components, based on respective longitudinal bending lines disposed in bottom surfaces of the respective recessed components, and the opposite second flanges contact the upper surface of the planar surface part; and
the welding includes, welding edges of the opposite second flanges contact the upper surface of the planar surface component are welded to the planar surface component and the bumper back beam includes a pair of closed section components defined by the recessed components.

3. The method according to claim 1, wherein, the first flanges are formed to be level with the planar surface part.

4. The method according to claim 1, wherein, the edges of the first flanges are welded to the planar surface component by spot welding, arc welding, or laser welding.

5. The method according to claim 1, further comprising:
heating the back beam;
forming the heated back beam in an arched shape with respect to the longitudinal direction; and
quenching the formed back beam.

6. The method according to claim 5, further comprising:
processing a surface of the bumper back beam.

7. The method according to claim 5, wherein the forming includes:
forming the bumper back beam and a curvature thereof varies from a medial portion thereof to opposite ends,
wherein the bumper back beam has a symmetrical structure based on the medial portion thereof.

8. The method according to claim 6, wherein the processing includes processing the surface of the bumper back beam using a shot blasting process.
